(19) United States
(12) Patent Application Publication
(10) Pub. No.: US 2012/0095931 A1
(43) Pub. Date: Apr. 19, 2012

(54) Contact Referral System and Method

(75) Inventors: Hope Gurion, Winnetka, IL (US); Nagini Indugula, Elmhurst, IL (US)

(73) Assignee: CareerBuilder, LLC, Chicago, IL (US)

(21) Appl. No.: 12/907,404

(22) Filed: Oct. 19, 2010

(51) Int. Cl. G06Q 10/00

(52) U.S. Cl. 705/319; 705/321

(57) ABSTRACT

A recruiting tool for leveraging social and business contacts of existing employees, contractors, franchisees and the like is disclosed. The system provides an application for evaluating contact data of employee contacts available through existing social networks or other applications. The application compares the contact data to opportunity description data and, if any of the contacts appear to possess the proper qualifications, matches those contacts to the opportunity of the employer. Feedback is provided to the employee identifying these matched contacts. The employee may then use the application to alert the matched contact of the opportunity, and to submit a referral to the employer relating to the matched contact. Additional system features and options for parties in the role of the employer, the employee, and the matched contacts are disclosed.

### TECHNICAL FIELD

This invention relates generally to systems and methods for recruiting, placement and human resources management, and more specifically, to systems and methods for utilizing an existing workforce or group of business partners to assist with, the presentation of job postings or other opportunities to qualified individuals or entities, and encouragement of those individuals or entities to submit applications relating to the job postings or other opportunities.

### BACKGROUND OF THE INVENTION

Employers are always striving to find efficient ways to discover and attract qualified job applicants. While positions requiring fewer qualifications may be easier to fill, most critical positions have more required qualifications and are more difficult to fill. Human resources personnel have traditionally utilized search firms or other third parties to help connect them with qualified applicants, especially for such critical positions. With the growth of the Internet, it has become common practice for employers to present job postings directly through their Internet websites. In many cases, the jobs can be applied for by applicants directly through the Internet. The Internet has the potential to present a job posting to a much larger audience than traditional means for broadcasting a job vacancy, such as a newspaper. However, the passive Internet job posting is still not likely to be seen by most qualified individuals, even if those individuals are in the market for such a job.

It is generally agreed among human resources professionals that personal referrals often lead to the best placements. This is particularly true when the referral comes from a well-respected employee of the company seeking to fill a position. Such an employee is likely to know not only whether the individual they are referring has the proper qualifications, but also whether that individual would fit with the personality and culture of the employer. Often this cannot be determined through an interview or a review of a resume. An employee's friends and contacts logically tend to have backgrounds and credentials similar to the employee. Perhaps they are classmates with the same educational background, or former co-workers with a similar level of experience. The employee's friends and contacts may, thus, comprise a fertile pool of potential job applicants. Accordingly, an employer's present employees can be a great resource in finding its future employees.

Many employers have taken advantage of this and instituted referral programs to help encourage their current employees to help bring in qualified applicants. However, this is, at best, a task that is peripheral to the employee's actual job, and may be too time intensive to get significant attention. In the case of larger employers that have new job postings weekly on even daily, an employee cannot be expected to keep up with the company's human resource needs. There is a need to make the referral process in such organizations easier for the current employees, so that they can quickly review the job postings and determine whether a referral would be appropriate. Though this need is easily understood with respect to a traditional employer/job vacancy scenario, it also transcends generally to a need for a system to help leverage existing relationships in order to locate individuals or entities to take on new opportunities or challenges.

### SUMMARY OF THE INVENTION

The present invention comprises systems and methods for assisting employees, or less specifically, referrers, to participate in the referral process. This results in the employers, or less specifically, the selectors, getting more referrals and applications from qualified applicants. Though the invention is primarily envisioned for use by employers to fill job vacancies through use of their employees, and those employee's personal contacts, it will be understood that the system can be used for other similar purposes, such as by an entity to fill contract positions or enlist contractors through the use of its existing relationships with other contractors, or to locate potential franchisors or owner/operators through its relationships with existing franchisors or owner/operators, etc. Accordingly, the general term “selector” is used to indicate the entity looking to fill a position or opportunity (e.g., an employer), while the general term “referrer” is used to indicate the entity or individual used by the selector (e.g., employee) to locate and refer an individual or entity (e.g., an employee's personal contact). The term “contact” is used generally to describe the personal or business contacts of the referrer. When describing certain embodiments, the terms “employee,” “employer” and “job description” might be used by way of example, however, it will be understood that the system could be applied in similar fashion to pair any referrer's contacts with any opportunity available through a selector.

In a particular embodiment, an employer makes its internal job posting data available to a server-based application. An employee of that employer then provides the server-based application with access to electronic data corresponding to the employee's contacts. This contact data may be, for instance, data related to the contact's geographic location, current employer, education level, or work history. The contact data and the job posting data may initially be in a non-standard form; however, the server-based application is capable of converting these data sets into comparable elements, as set forth in Applicant's prior pending application, U.S. Ser. No. 11/622,572 (“the '572 Application”). The server-based application then compares the converted data sets to determine which of the employee's contacts might be good matches for the position. In some embodiments, the matched contacts are presented to the employee, and referrals are requested. In other embodiments, the matched contacts may be sent information about the job posting, and a job application is requested.

Thus, the invention provides a new and useful means for increasing referrer involvement in the process of filling a selector's vacancies and opportunities, and particularly in locating talented, qualified applicants to fill job vacancies. While certain embodiments are referenced above, other embodiments, systems, methods, features, and advantages of the present invention will be, or will become, apparent to one having ordinary skill in the art upon examination of the following figures and detailed description. It is intended that all such additional systems, methods, features, and advantages included within this description, be within the scope of the present invention, and be protected by the accompanying claims.

### BRIEF DESCRIPTION OF THE DRAWINGS

The present invention can be better understood with reference to the following figures. The components in the figures are not necessarily to scale, emphasis instead being placed upon clearly illustrating the principles of the present invention. In the figures, like reference numerals designate corresponding parts throughout the several views.

FIG. 1 is a graphical representation of certain components of a contact referral system.

FIG. 2 is a block diagram of the interfaces in the contact referral system of FIG. 1.

FIG. 3 is a block diagram of one form of a communication device or server of FIG. 1 and/or FIG. 2, having a memory element with a computer readable medium for implementing the contact referral system.

FIG. 4 is a flowchart depicting steps involved with setting up the contact referral system to work with a given selector and set of referrers, according to certain embodiments.

FIG. 5 is a flowchart depicting steps involved in executing a comparison of contact data to opportunity description data, according to certain embodiments.

FIG. 6 is sample opportunity description data in the form of a job posting.

FIG. 7 is a sample summary record created from sample contact data.

FIG. 8 is sample contact data from a FaceBook® application.

FIG. 9 is sample contact data from a LinkedIn® application.

FIG. 10 is a sample screen display showing results from an execution of the contact referral system application by a referrer, according to certain embodiments.

FIG. 11 is a sample screen display illustrating the ability for a referrer to share job details with all of the referrer's contacts.

FIG. 12 is a sample screen display showing matched contacts for a particular opportunity, according to certain embodiments.

FIG. 13 is a flowchart depicting the steps that a referrer and a matched contact might take to follow through on a system-generated match to a particular opportunity.

FIG. 14 is a sample screen display illustrating the ability for a referrer to send a message about an opportunity to one or more specific contacts.

FIG. 15 is a sample screen display that a contact might see as a result of the message generated at the screen display of FIG. 14.

FIG. 16 is a sample screen display showing a full opportunity description that the system might present to a matched contact, according to certain embodiments.

FIG. 17 is a sample screen display illustrating the ability for a contact to request a referral from the referrer that sent the contact the message relating to the opportunity.

### DETAILED DESCRIPTION

The description that follows describes, illustrates and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended, claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. The present specification is intended to be taken as a whole and interpreted in accordance with the principles of the present invention as taught herein and understood to one of ordinary skill in the art.

The present invention utilizes an existing communication network to help link qualified individuals or entities with opportunities offered by a selector through the use of references known to the selector. In one scenario, the system is extended by an employer to its existing employees for use in filling the employer's job vacancies. In this scenario, the employer would be the selector and the employees would act as referrers. Though the system is not limited to use in such a scenario, this is the scenario used as the primary example for purposes of describing the system herein.

As will be further discussed, a contact referral system application resides on a server within the network. The application has access to both the employer's job posting data and the employee's contact data. This contact data may exist in various electronic forms. In one embodiment, the data may be within a database on the employee's (referrer's) communication device, such as a database associated with an email program or an electronic address book. In another embodiment, the contact data may reside on a social network server, such as FaceBook® or LinkedIn®. In this case, it is the contact, not the employee, that actually placed the contact data on the social network server; but the employee nevertheless provides access to the contact data by way of being connected to the contact through the social network application.

The employee can use the contact referral system application to match the employee's contacts with job postings at his or her employer. Once the application matches qualified contacts with job vacancies or other opportunities, the employee can determine whether or not to alert the matched contacts to the associated job posting or availability. For those matched contacts notified of the job posting through the contact referral system application, they may use the application to apply for the job and/or request a referral from the current employee that connected them with the job posting. The employer, thus, increases its chances of receiving applications from qualified candidates, complete with referrals from a known source, through use of and subscription to the contact referral system.

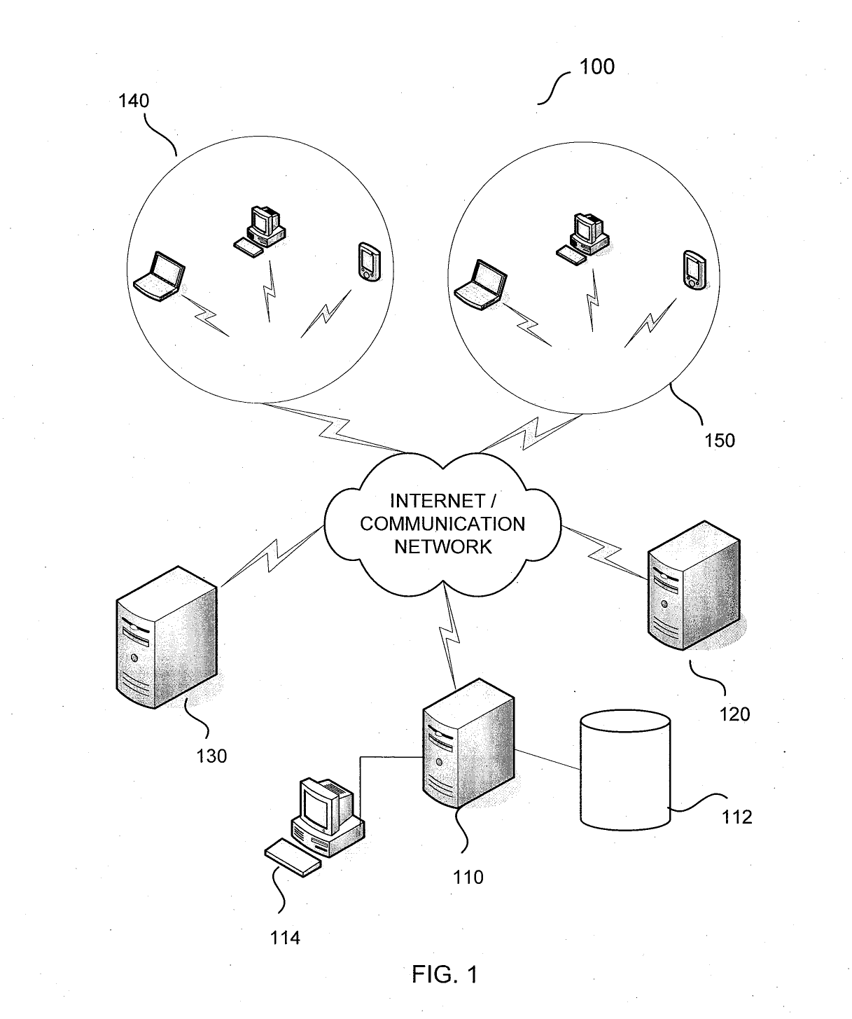

FIGS. 1-3 illustrate the electronic components of the system, and the manner in which they may be connected, according to certain embodiments. FIG. 1 is a graphical representation of a computer-based or implemented contact referral system 100. The system includes a plurality of referrer communication devices 140 and contact communication devices 150, which can be any variety of hardware device that is capable of connection to and communication with a network, such as the Internet or other computer network, in a manner which is known in the art and which will be further understood from the below description. Each of the communication devices 140 and 150 can run an interface program, such as an Internet browser application for connecting to the Internet/network, which is capable of communicating with the contact referral system 100, which can be server-based. Specifically, for communicating with communication devices 140 and 150, a contact referral system server 110 is connected to and in communication with a network, such as the Internet, in a manner which is known in the art. Firewall and other security systems and applications (not shown) may be used to prevent and deter unauthorized access to contact referral system server 110, as is known in the computer networking art. Contact referral system server 110 is further connected to contact referral system database 112, which is used to store various data sets and other information.

Social network server 120 and selector server 130 are separately connected to and in communication with the network, such as the Internet, in a similar manner. Though shown to be an individual server, it will be understood that contact referral system 100 may accommodate numerous selector servers 130, each transmitting opportunity description data from different employers or other selectors, as discussed below. In addition, there may be multiple social network servers, which may contain separate contact information and operate different social networks, such as, for instance, FaceBook®, LinkedIn®, ZoomInfo®, Spoke™, Xing®, Ryze®, BoardEx™ or Viadeo™.

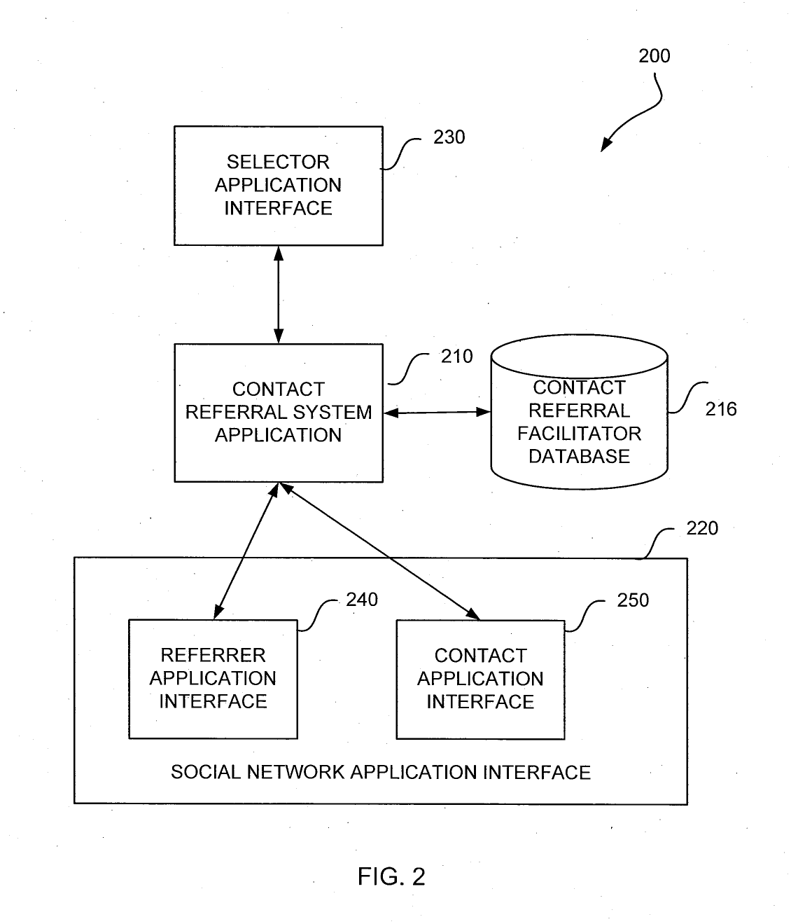

Contact referral system server 110 houses and operates contact referral system application 210. FIG. 2 shows that contact referral system application 210 interacts through the network with referrer application interface 240, selector application interface 230, and contact application interface 250. For the contact referral system server 110 and contact referral system application 210 therein, a contact referral system administrator computer 114, shown in FIG. 1, is connected to and placed in communication with the contact referral system server 110 for interfacing with the contact referral system server 110 to provide installation, set-up, and/or ongoing maintenance interface functions.

FIG. 2 is a block diagram of a computer-based or implemented system 200 for facilitating communication within the contact referral system 100 of FIG. 1. Specifically, each referrer communication device 140 of FIG. 1 can enable employees to interface with contact referral system application 210 through an referrer application interface 240. The referrer application interface 240 may be a stand-alone application interface, or may utilize, and comport with, an existing social network application interface 220, which operates through social network server 120. Similarly, contact communication device 150 of FIG. 1 can enable a contact of the referrer to interface with the contact referral system application 210 through contact application interface 250. As shown, contact application interface 250 may also operate within or share social network interface 220. Adaptation of contact application interface 250 and referrer application interface 240 for use with or within social network application interface 220, has several advantages. Social network application interface 220, which may be, for instance, FaceBook®, is likely to be well-known to both referrers and contacts, allowing them to easily use and navigate through the application for communication with contact referral system application 210.

Though most of the communication between contact referral system server 110 and selector server 130 is automated, selector application interface 230 is provided on selector server 130 to enable a selector to interface with the contact referral system application 210 if desired. The contact referral system application 210 of FIG. 2 can represent and generate various sets of interface screens and provide functionality for performing all of the functions provided by the contact referral system 100, and is further connected to and in communication with a contact referral facilitator database 216 residing within a memory.

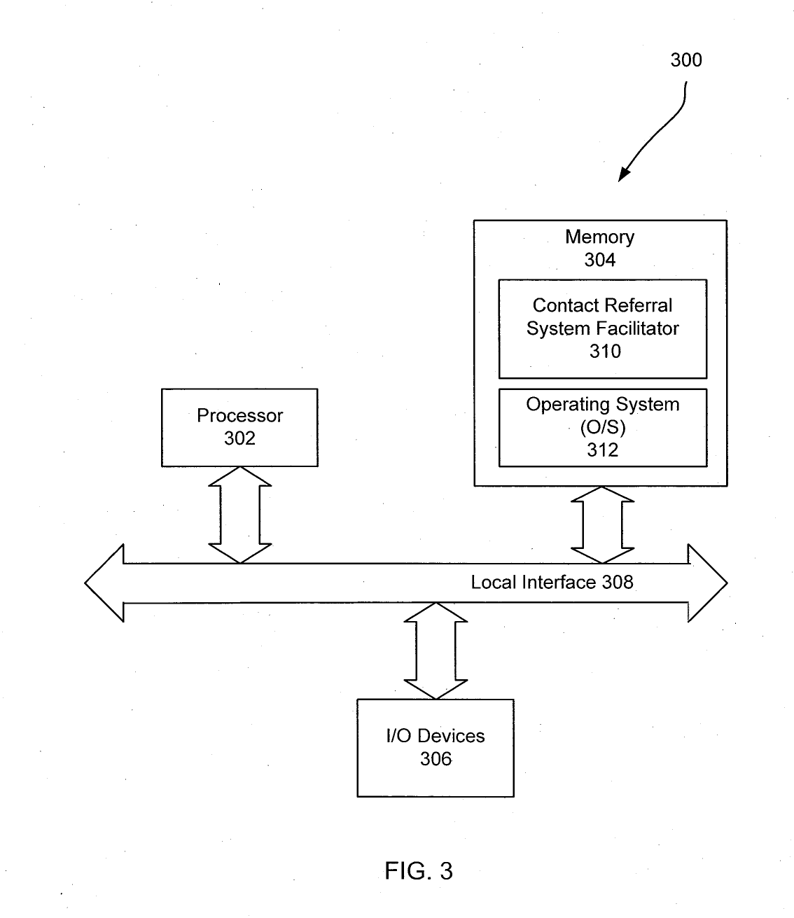

FIG. 3 is a block diagram of a computer 300 housing one or more software applications which are a part of and/or facilitate the contact referral system 100. Computer 300 may be any one of contact referral system server 110, contact referral system administrator computer 114, selector server 130, referrer communication device 140, and/or or contact communication device 150 from FIG. 1. Referral system facilitator 310 represents a stand-alone software program that may be used in some embodiments. However, in the preferred embodiment, no individual software application is needed for referrer communication device 140 or contact communication device 150. Accordingly, for these devices, contact referral system facilitator 310 would simply comprise an Internet browsing interface application. Computer 300 may include a memory element 304. Memory element 304 may include a computer readable medium for implementing the contact referral system 100.

The contact referral system facilitator 310 may be implemented in software, firmware, hardware, or any combination thereof. For example, in one mode, the contact referral system facilitator 310 is implemented in software, as an executable program, and is executed by one or more special or general purpose digital computer(s), such as a personal computer (PC; IBM-compatible, Apple-compatible, or otherwise), personal digital assistant, workstation, minicomputer, mainframe computer, computer network, “virtual network” or “internet cloud computing facility”. Therefore, computer 300 may be representative of any computer in which the contact referral system facilitator 310 resides or partially resides, such as the contact referral system server 110 of FIG. 1.

Generally, in terms of hardware architecture, FIG. 3 shows that computer 300 includes a processor 302, memory 304, and one or more input and/or output (I/O) devices 306 (or peripherals) that are communicatively coupled via a local interface 308. Local interface 308 may be, for example, but is not limited to, one or more buses or other wired or wireless connections, as is known in the art. Local interface 308 may have additional elements, which are omitted for simplicity, such as controllers, buffers (caches), drivers, repeaters, and receivers, to enable communications. Further, local interface 308 may include address, control, and/or data connections to enable appropriate communications among the other computer components.

Processor 302 is a hardware device for executing software, particularly software stored in memory 304. Processor 302 can be any custom made or commercially available processor, a central processing unit (CPU), an auxiliary processor among several processors associated with computer 300, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. Processor 302 may also represent a distributed processing architecture such as, but not limited to, SQL, Smalltalk, APL, KLisp, Snobol, Developer 200, MUMPS/Magic.

Memory 304 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 304 may incorporate electronic, magnetic, optical, and/or other types of storage media. Memory 304 can have a distributed architecture where various components are situated remote from one another, but are still accessed by processor 302.

The software in memory 304 may include one or more separate programs. The separate programs comprise ordered listings of executable instructions for implementing logical functions. In the example of FIG. 3, the software in memory 304 includes the contact referral system facilitator 310 in accordance with the present invention, and a suitable operating system (O/S) 312. A non-exhaustive list of examples of suitable commercially available operating systems 312 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system 312 essentially controls the execution of other computer programs, such as the contact referral system facilitator 310, and provides scheduling, input-output control, file and data management, memory management, and communication control and related services.

The contact referral system facilitator 310 may be a source program, executable program (object code), script, or any other entity comprising a set of instructions to be performed. When a “source” program, the program needs to be translated via a compiler, assembler, interpreter, or the like, which may or may not be included within memory 304, so as to operate properly in connection with operating system 312. Furthermore, the contact referral system facilitator 310 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, .Net, HTML, and Ada. In one embodiment, the contact referral system facilitator 310 is written in Java.

I/O devices 306 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, I/O devices 306 may also include output devices, for example but not limited to, output modules for PLCs, a printer, bar code printers, displays, etc. Finally, I/O devices 306 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

If computer 300 is a PC, workstation, PDA, or the like, the software in memory 304 may further include a basic input output system (BIOS) (not shown in FIG. 3). The BIOS is a set of essential software routines that initialize and test hardware at startup, start O/S 312, and support the transfer of data among the hardware devices. The BIOS is stored in ROM so that the BIOS can be executed when computer 300 is activated.

When computer 300 is in operation, processor 302 is configured to execute software stored within memory 304, to communicate data to and from memory 304, and to generally control operations of computer 300 pursuant to the software. The contact referral system facilitator 310, and O/S 312, in whole or in part, but typically the latter, may be read by processor 302, buffered within processor 302, and then executed.

When the contact referral system facilitator 310 is implemented in software like in FIG. 3, it should be noted that the contact referral system facilitator 310 can be stored on any computer readable medium for use by or in connection with any computer related system or method, although in one preferred embodiment, the contact referral system facilitator 310 is implemented in a centralized application service provider (ASP) arrangement. In the context of this document, a computer readable medium is an electronic, magnetic, optical, or other physical device or means that can contain or store a computer program for use by or in connection with a computer related system or method. The contact referral system facilitator 310 can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, because the program can be electronically captured, via, for instance, optical scanning of the paper or other medium, then compiled, interpreted or otherwise processed in a suitable manner if necessary, and then stored in a computer memory.

In another embodiment, where the contact referral system facilitator 310 is implemented in hardware, the contact referral system facilitator 310 may also be implemented with any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As mentioned above, contact referral system application 210 can be adapted for use with various social networking applications. This is necessary in cases where it is desirable to use the social networking application as an interface between the referrer communication device 140 and the contact referral system server 110. This also allows the referrer to grant contact referral system server 110 access to certain contact data stored on the social network server 120. Though the contact referral system 100 may be adapted for use with, and works in substantially the same way with, various other social networking applications, the illustrated embodiment discussed herein is adapted for use with FaceBook®.

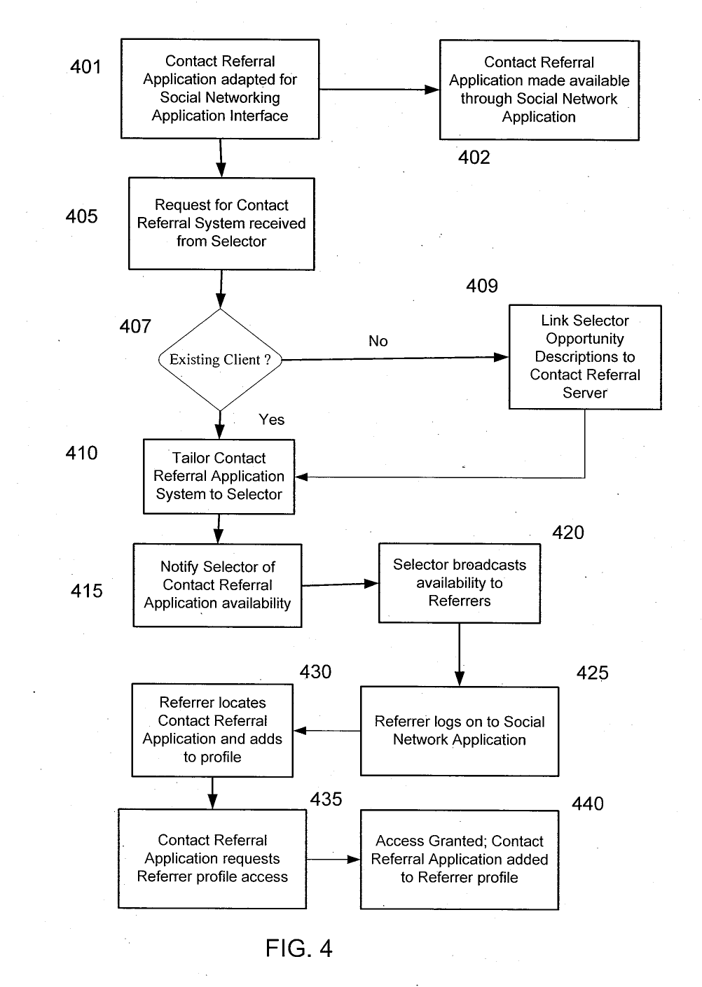

FIG. 4 is a flow chart showing the steps involved with establishing contact referral system service for an employer (in the role of selector), and preparing an employee (in the role of referrer) to interface with and/or execute the contact referral system application 210. At step 401, contact referral system application 210 is adapted for interaction with social network application interface 220, and specifically for interface with referrer application interface 240 and contact application interface 250 through social network application interface 220. This is done, for instance, by ensuring that contact referral system application 210 is in accordance with the social network application programming interface. Though this step is a programming step that need only be done once per social network, it is included for full disclosure. The exact subcomponents of this step will depend on the particular guidelines and parameters of the social network itself, which are known to those skilled in the art. For instance, with respect to FaceBook®, there are certain publicly available programming guidelines provided for creation of software applications that can be downloaded through, and available in association with, FaceBook®. Once step 401 is completed, it need not be repeated unless adaptation to a different social network is desired, or unless changes to the existing interface are desired.

Once the contact referral system application 210 is properly adapted, it is made available for use through social network application interface 220, at step 402. This can be done by sending data and a proper link from contact referral system server 110 to social network server 120. Once this is done, individuals interfacing with social network server 120 through social network application interface 220 can locate and download the data and link relating to the contact referral system application 210. For instance, in FaceBook®, this will allow an individual to position a link to application 210 within their FaceBook® profile so that the individual will be able to interface with or execute contact referral system application 210 through the FaceBook® application interface. It will be understood that, though it could, this step will not typically involve downloading contact referral system application 210 itself onto social network server 210 so that it operates from social network server 210. Rather, in the preferred embodiment, contact referral system application 210 remains on contact referral system server 110, but is operated through social network application interface 220, which is managed by social network server 210 via a series of links. Thus, social network application interface 220 is used as a conduit for interfacing with referrer communication device 140 and/or contact communication device 150.

The next preparatory step is to link contact referral system application 210 with one or more employers. At step 405, an employer requests service from the contact referral system. It is assumed that this employer has electronic job postings created and available through selector server 130. These postings may or may not be posted on the employer website and available for viewing over the Internet, but they do need to be made available to contact referral system server 110. Thus, if there is not already a secure link established between selector server 130 and contact referral system server 110 for the purpose of gathering the job posting data, this link must be established at Step 409. Once job posting data from the employer is available to contact referral system server 110, some further adaptation to contact referral system application 210 may be desirable so as to tailor the referrer application interface 240 to look more familiar to the employee. For instance, at step 410, the interface 240 may want to incorporate the employer's marks, or may want to present in a frame or partition that is customary for web pages belonging to the employer. This adaptation may also be desirable for contact application interface 250, for purposes of marketing the employer and its job vacancy to the contact.

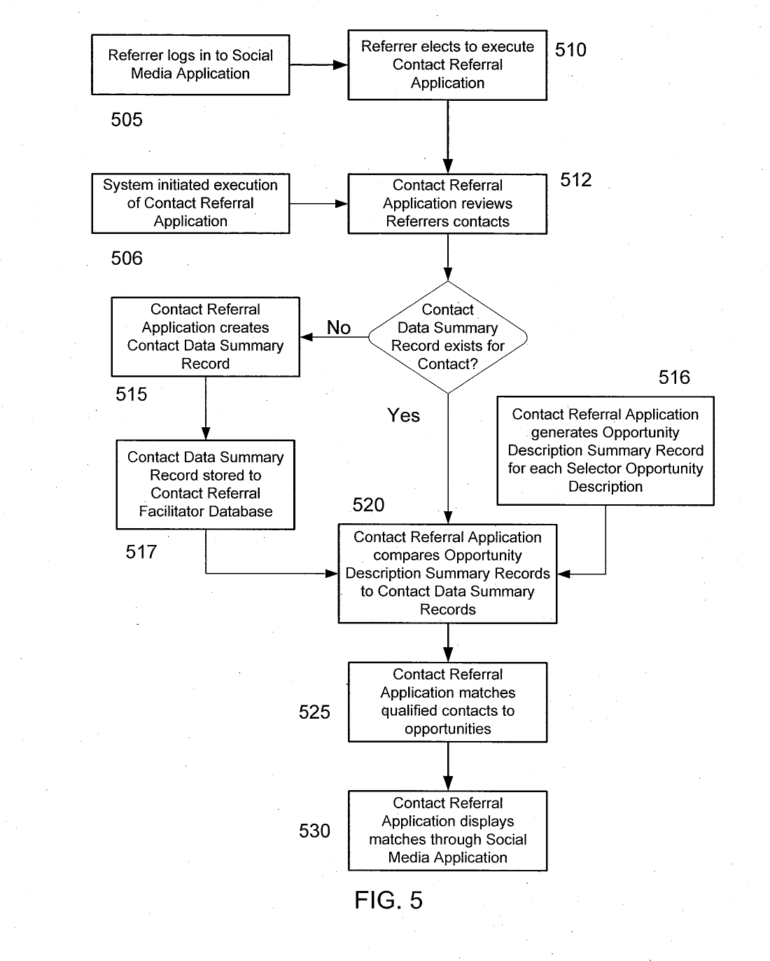

Once these preparatory steps are complete, it is helpful to alert the employees to the availability of the contact referral service, and possibly to institute or reassert an incentive program that rewards employers for making referrals that lead to full-time hires. At step 415, the employer is notified that the contact referral system application 210 has been properly adapted, is linked to the selector server 130, and is ready for download by employees through social network application interface 220. The employer then advises its employees of the service availability and encourages participation at step 420. It is assumed that at least some of the employees will have profiles created on the social networks for which contact referral system application 210 will have been adapted. At step 425, those employees access their profiles and search for the link to contact referral system application 210. The link is found at step 430, and the employees request to add the link to their profiles. At this point in the illustrated embodiment, step 435, the social network application interface 220 will ask the employees if they wish to grant contact referral system application 210 access to their profiles. Most social network applications will require this step so as to maintain security. Once an employee grants permission, at step 440, contact referral system application 210 will be added to that employee's social network profile. As explained below, the system application 210 may proceed to the execution stage shown in FIG. 5 at this point or may await a request to do so from the employee.

With these steps complete, contact referral system server 110 will be able to access an employee's contact data housed within the social network. Accessing the employee's contact data through a social network in this manner has certain advantages over accessing such data that might be housed directly on referrer communication device 140. Though accessing contact data housed on referrer communication device 140, such as in association with an email application like Microsoft Outlook® or a data file on a cell phone, is also contemplated, such contact data is reliant on the employee to keep it current. Alternatively, contact data in a social network environment is input and kept current by the contacts themselves. In addition, contact data in a social network is likely to contain more relevant information than contact information that would likely be found on referrer communication device 140, such as a basic address, phone number, or email address.

FIG. 5 is a flowchart that sets forth certain execution steps that an employee may initiate through referrer application interface 240, or that may be automatically initiated by system application 210, once the proper links are in place as discussed above. At step 505, the employee logs in to the social network through social network application interface 220 and elects to execute the contact referral system application 210 through the link within the employee's social network profile. This action launches referrer application interface 240 within social network application interface 220, and causes contact referral system application 210 to initiate a series of steps to compare the employee's contact data to the job posting data available through selector server 130. Alternatively, at Step 506, system application 210 executes automatically. This may occur immediately after profile access is granted at Step 440, in which case results are generated (as explained below) upon system signup. In addition, or alternatively, system application 210 may be programmed to execute at a set time each night or each week, etc. In this matter, updated results will be available to the referrer immediately upon log in and request.

Regardless of how system application 210 initiates, it first sorts through the referrer's contacts at Step 512 to determine for each such contact if a contact data summary record has already been created and stored in the contact referral facilitator database 216. If it has, steps 515 and 517 may be bypassed for that contact. It is preferred that each contact data summary record will have a timestamp indicating when it was created. In this manner, system application 210 may be programmed to generate an updated contact data summary record for a contact where the existing one has become too old. In this manner, the contact referral system 100 accounts for periodic changes that will be made to contact data by the contacts themselves as those contacts update their profiles through the social network application interface 220 from time to time.

In the illustrated embodiment, the execution process involves breaking down non-standard data sets into summary records that can be compared and ranked through an algorithm in order to determine matches. Through this process, the contact referral system locates qualified contacts, if any, for each job posting from among the employee's total set of contacts within the social network and matches those contacts with the corresponding job vacancies. As discussed, the job posting data sets (or more broadly, the opportunity description data sets) and the contact data sets will likely be of non-standard form. There are a number of ways that the data could be parsed to determine qualified contacts from among the full set of contacts. For instance, contact referral system application 210 could utilize a simple word matching, or search function, wherein the application searches within the contact data sets for certain keywords relating to each opportunity. While that method may be adequate in some cases, in other cases a more advanced process may be needed to provide a more robust comparison of the opportunity description data sets and the contact data sets in order to determine higher-confidence matches. The more refined the process of matching contacts to opportunities is, the higher confidence there can be that recommended contacts are actually qualified. Thus, the illustrated embodiment focuses on the creation of, comparison of, and ranking of summary records from the original non-standard data sets.

Steps 515, 516, the comparison step of 520, and the matching step of 525 are preferably executed in accordance with the data set comparison process described in the '572 Application, which is incorporated by reference herein in its entirety, with the exception that the term “profile” as used in that application is referred to herein as “summary record” to avoid confusion due to the fact that a “profile” is generally understood in the art of social networking to indicate the content of an individual's social network web page, which is relevant to the present application.

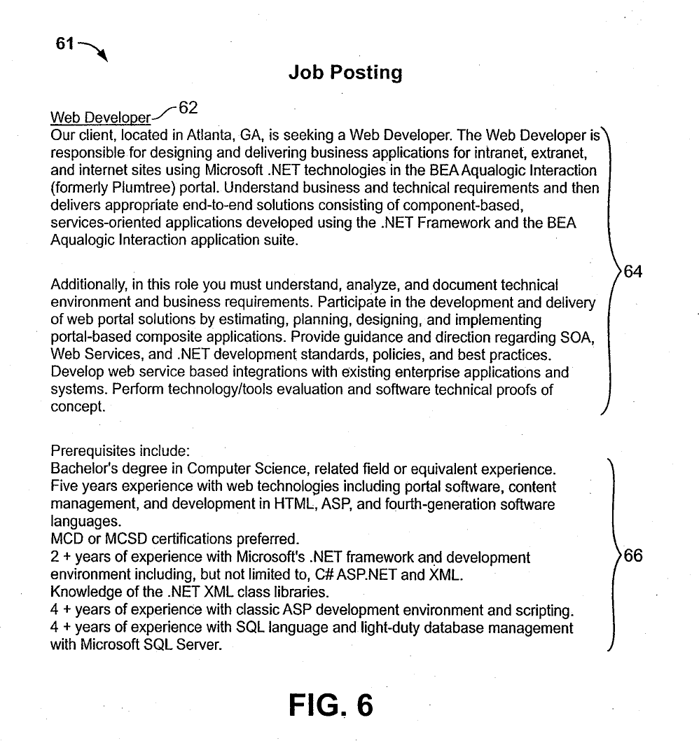

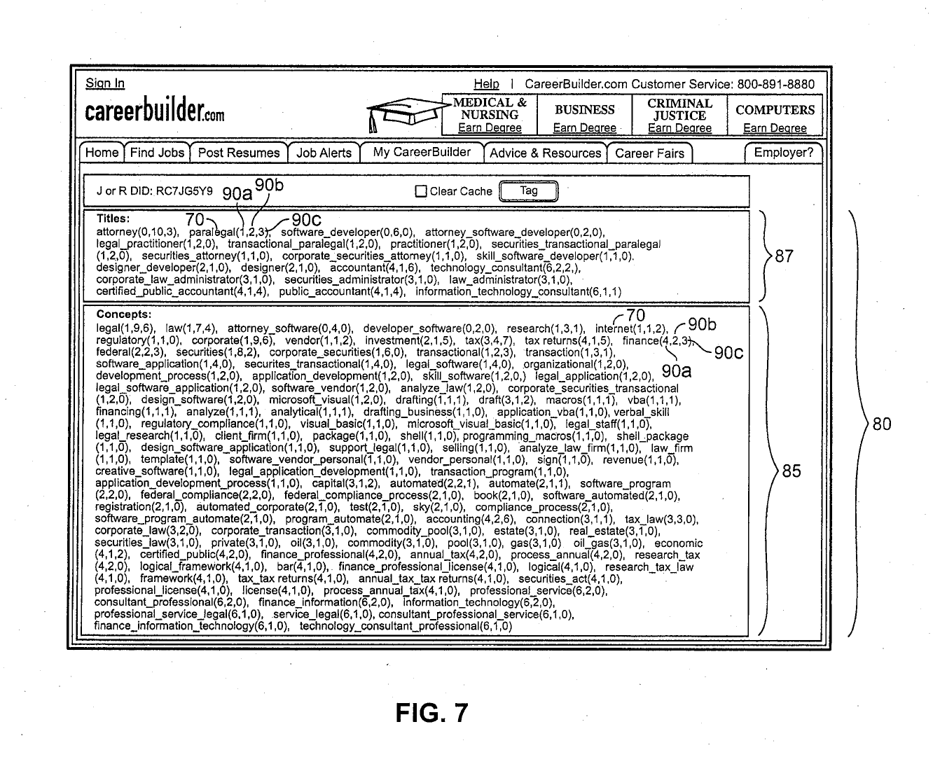

In the illustrated embodiment relating to an employer/employee scenario, the process of creating a summary record at step 516 works much the same as is set forth in the '572 Application, because a full job posting is available. For instance, FIG. 6 shows a sample job posting for a web developer position in Atlanta. Such a job posting would typically provide a title 62, a job description 64, and the qualifications or criteria 66 for the job posting 61, including the type and level of education, professional credentials, and experience that a qualified job seeker should possess. Contact referral system application 210 would break the job posting down into bands and band arrays, then proceed to analyze the text in each band, and place that text into word arrays, all of which is explained and depicted in detail in the '572 Application. Ultimately, a standardized set of attributes is organized into a summary record having a standard ranking or scaling scheme. FIG. 7 shows an example of a summary record 80 that might result from such a non-standard data set. The summary record 80 is comprised of attributes 70, which are words and terms categorized as titles 87 or concepts 85. Each attribute is assigned values which correspond to certain metrics 90a, 90b, and 90c. These metrics may correspond to the band within the original data set, the number of occurrences of the attribute within the data set, or a quantification for the level of support for the attribute found in the remainder of the data set.

For its principal example, the '572 Application illustrated the creation of a summary record from a resume. However, it noted that the process would be essentially the same for a job posting, with certain alterations to account for the different content delineations expected in a typical job posting format. This variation is again required to modify the '572 Application process of summary record creation to account for the smaller amount of information that is likely to be available through contact data, or through some opportunity descriptions not related to a job vacancy that may have limited details. For example, though the amount of contact data available will vary significantly, most social network environments will not contain nearly as much applicable information as might be found on an individual's resume. Thus, while step 516 will operate in the same manner as set forth in the '572 Application when the opportunity description is a detailed job posting, step 515 will often involve an abbreviated process that would result in an abbreviated summary record. Though the steps taken are the same, there will be much fewer attributes 70 in the summary record 80 once the process is complete. Just like the quality of a resume is in the hands of a job applicant, the quality and content of the contact data made available through a social network is in the hands of the contact responsible for posting that data. The more complete and accurate that contact data is, the more likely the contact referral system application 210 will be able to match the contact with a job posting or other opportunity.

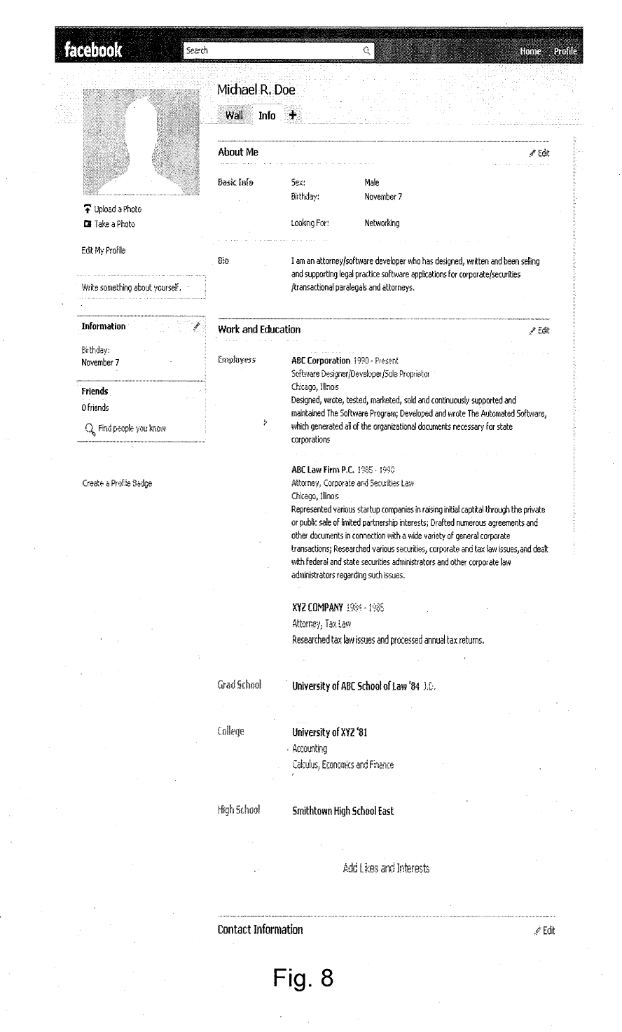

FIG. 8 shows a sample of contact data that a referrer's contact might make available through the contact's FaceBook® social network profile. FaceBook® profiles will typically have a number of tabs 801 along the top border. In FIG. 8, the “info” tab has been selected. Though contact referral system application 210 may process contact data from other tabs, the info tab is the tab that is most likely to have data relevant to the present invention. The info tab will typically contain an “about me” section 805, a “work and education” section 810, a “likes and interests” section 815, and a “contact information” section 820. These latter sections have not been populated in the illustrated sample because they are less likely to contain relevant contact data. The sections of the info tab are pre-set by the FaceBook® social network application, however it is up to the contact whether the sections provide accurate or detailed information sufficient to create a useful summary record 80. In the present example, the contact data reveals several aspects potentially relevant to a job posting, such as the contact's age, sex, geographic location, prior work experience, and education.

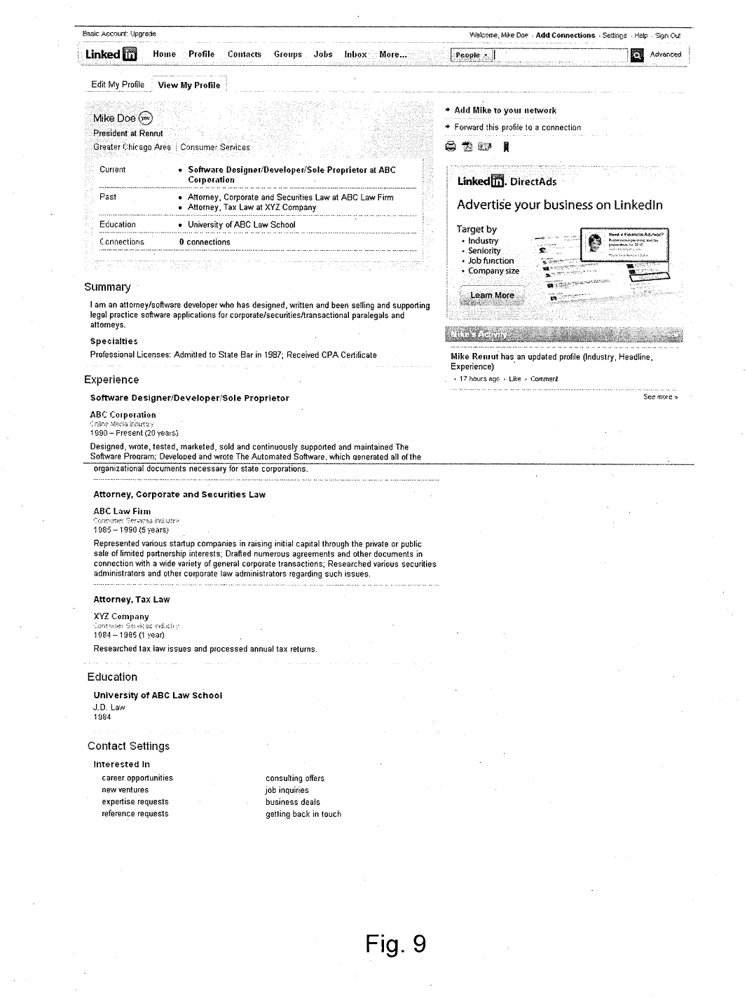

While FaceBook® is directed to social connections, other social network applications are designed more toward building and maintaining business connections. Not surprisingly, the contact data found in the contact profiles within these latter types of social networks are likely to have higher concentrations of data containing attributes relevant to a given job posting. For example, FIG. 9 shows a sample of contact data that might be included in a contact's LinkedIn® profile. This profile is more similar to a resume format, where detailed information regarding work experience, education, roles and responsibilities are provided. Though not present in the illustrated example, the profile may also contain recommendations from co-workers, supervisors, or clients. Accordingly, this contact data set will create a robust summary record for contact referral system application 210 to compare to each relevant job posting. In fact, the profile of FIG. 9 contains the same basic data that was used to generate the summary record of FIG. 7, from the sample resume of FIG. 6.

Returning to FIG. 5, it will now be appreciated that steps 515 and 516 may happen independently, and based on different events. As explained above, summary records are created for each of a referrer's contacts at the time the referrer chooses to execute the contact referral system application 210, or periodically during periods of low system usage. Alternatively, step 516 (creation of summary records from job posting data) typically occurs automatically, regardless of the actions of a referrer. The frequency that this step occurs will typically be aligned with the frequency that a particular employer adds or removes job postings. For large employees, the frequency for executing step 516 may be daily or even hourly. For smaller employees, the time lag may be longer. Alternatively, execution may be based on a request sent by the selector through selector application interface 230. In any event, step 516 essentially sweeps new opportunities into the contact referral system 100 and removes expired opportunities. For each new opportunity, a summary record is created and stored on contact referral system database 112.

In other embodiments, step 516 is triggered when the referrer executes step 515. In this case, new opportunity description summary records will only be created for opportunities that have not already been created and stored in contact referral system database 112. If an opportunity description summary record has been created for a given opportunity, the system 210 will simply pull it from contact referral facilitator database 112. The contact referral system 100 can also track which opportunities are new to the referrer executing contact referral system application 210, and only present results relating to those opportunities. In other words, assuming the referrer has executed the application 210 previously, the application 210 would only provide results for opportunities added to the system by the selector since the last execution of the system by the referrer.

Returning to the employer/job posting scenario, at step 520, contact referral system application 210 compares the contact summary records created for each of the employee's contacts within the social network to the job posting summary records for each of the job postings available through the employer. As a result of this comparison, the contact referral system application 210 determines matches between job postings and employee contacts at step 525, and, at step 530, presents its findings through the referrer application interface 240, within social network application interface 220.

The process of comparing and determining matches is fully set forth in the '572 Application. As described therein in greater detail, the summary records may be assigned numerical values which then can be compared using known software search applications such as FAST Data Search™. Each attribute 70 within a given job posting summary record 80, now a numerical data set, can be searched for and identified within the various contact data summary records. Furthermore, the attributes can be assigned different weights, such that the presence of certain attributes in a contact data summary record will increase the chance that the corresponding contact will be a match more than the presence of other attributes. By way of example, the attribute “certified_public_accountant” in the contact data record summary of FIG. 7 would likely be weighted very high if the job posting relates to a financial accountant position, whereas it would likely be weighted much lower if the job posting related to a marketing supervisor position.

The sensitivity of contact referral system application 210 may be adjusted at the request of the employer, or by the system administrator, such as through contact referral system administrator computer 114. This sensitivity correlates to a numerical determination of what constitutes a match. If the system application 210 is not producing any matches from among a pool of contacts that, from an objective review, contains qualified candidates for a given opportunity, the sensitivity may be too high. Alternatively, if contact referral system 100 is resulting in referrals of numerous contacts that are objectively determined to be unqualified, the sensitivity may need to be raised. As further explained in the '572 Application, it is actually possible to rank order all of the contact data summary records for a given opportunity description summary record. In this manner, contact referral system application 210 can provide results to the referrer that not only identify the contacts that match opportunities, but also present them in a ranked order.

In cases where a selector is very large and there are a very high number of opportunities available at any one time, the referrer may select or submit a subset of opportunity description summary records for the comparison step so as to reduce processing time and avoid generating a result that might overwhelm the referrer. In some embodiments, a referrer may be able to select a particular job posting, or a subset of job postings based on, for example, discipline or geography, for submission to the contact referral application system 210. Alternatively, the contact referral system application 210 itself may determine what job postings to submit based on the job description of the employer himself. In other embodiments, the employee may be able to select individual contacts for submission to the contact referral system application 210. In this manner, the employee might elect to submit a contact that the employee knows to be in the market for a new job, and receive a result that will identify all potential matches for that contact within the employee's company.

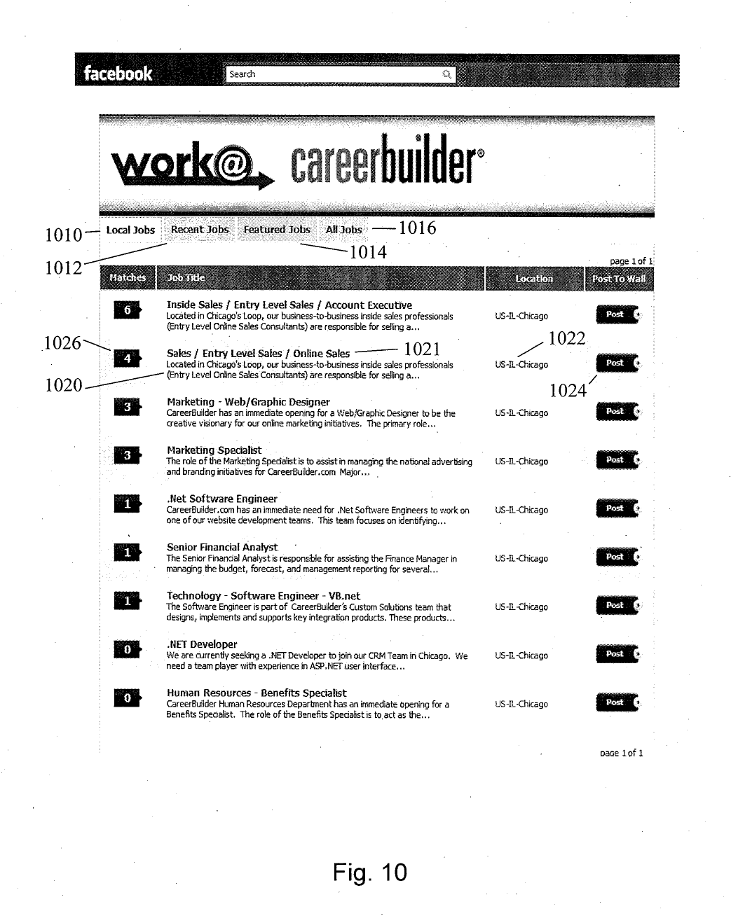

FIGS. 10-12 and 14-17 show sample screen displays of the system application 210 in use by an employee looking to refer contacts to his or her employer. It will be understood from the description above that the referrer need not be an employee, the selector need not by an employer, and the opportunity need not be a job vacancy. However, these terms are substituted in the description associated with these figures to provide an example of system operation.

FIG. 10 shows an example of a recommendation display generated through referrer application interface 240, which in this embodiment is provided through the FaceBook® social network application. Though the recommendation display shown features the CareerBuilder® logo, this would typically be replaced by and branded with the logo of the selector. Along the top, the display shows local jobs tab 1010, recent jobs tab 1012, featured jobs tab 1014, and all jobs tab 1016. The local jobs tab 1010 is the view shown in FIG. 10, and may be used as the default view. In this view, only the job postings near the area where the employee works are shown. Because contact referral system application 210 will have access to the information the employee has posted on the social media server 120 as well, it will recognize where the employee works. Alternatively, the application 210 could require the employee to submit certain background information prior to downloading the application, at step 430 of FIG. 4. Note in FIG. 10 that the location for all of the listed jobs is Chicago. This view is helpful because the employee is likely to have more contacts in the local area.

As shown, results are listed in order of the number of matched contacts that were found by contact referral system application 210 for each job posting. This same style of presentation would be displayed if the employee selected recent jobs tab 1012 or featured jobs tab 1014. However, recent jobs tab 1012 would only show job postings that have been recently added by the employer. The recent jobs view is helpful to frequent users of the contact referral system application 210. Most likely these users would have already reviewed and either discarded or acted upon the matches to the older job postings. Featured jobs tab 1014 would display those jobs designated by the employer as being high need areas, or jobs for which the employer most wants to attract contact referrals.

The all jobs tab 1016 is the only view that would not necessarily reveal matches as shown in FIG. 10. Rather, in most embodiments, it would simply show a list of all the job postings for the employer, with links to specific job descriptions. Not submitting every single job posting of an employer to the comparison step every time contact referral system application 210 is executed is another means for controlling the load on the contact referral system 100, and may speed the execution time in the case of large employers with hundreds of simultaneous job postings. In addition, using the tab scheme to show limited results prevents the employee from being overwhelmed with matches. If, upon reviewing the all jobs tab 1016, the employee recognizes certain jobs of interest, those jobs could then be manually submitted by the employee for comparison by the contact referral system application 210. In some embodiments, the contact referral system application 210 may be customizable by the employee to generate other tabs as well. For instance, the employee might want to execute the comparison step for all jobs relating to a certain discipline, all jobs within a specific salary range, or all jobs meeting certain other criteria such as part-time employment, etc.

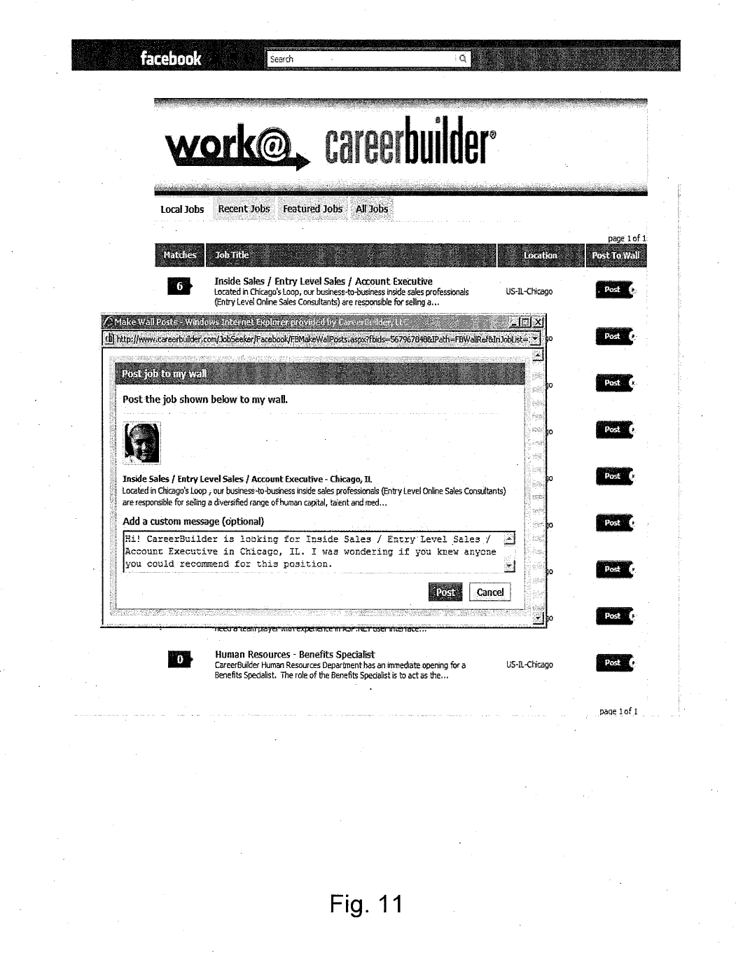

Each job posting listed in the results screen of FIG. 10 shows a job description 1020, a job location 1022, a post link 1024, and a matches link 1026. At the top of each job description is a job title link 1021, which, when selected, provides the employee a more complete job description for the particular job posting, such as that of FIG. 6, through referrer application interface 240. The post link 1024 allows an employee to post information relating to the job posting on the employee's profile within the social network application interface 220. This allows the employee to “broadcast” a job posting to all of their contacts rather than send out targeted notices to matched contacts. FIG. 11 shows an example where an employee has elected to post a job to her “wall.” In this case, the employee is accessing the contact referral system 100 through the FaceBook® social network application interface, wherein a user's “wall” is viewable by the user's friends and contacts. Upon selecting the post link 1024 next to the job description 1020, contact referral system application 210 generates a new window through referrer application interface 240. In the illustrated embodiment, the window also provides the opportunity to include a custom message to the employee's contacts to accompany the job information.

From a data standpoint, posting information relating to a job posting in this manner copies the job posting information from the contact referral system server 110 to the social network server 120. From a practical standpoint, it allows all of the employee's contacts within that social network to see the job posting data regardless of whether the contact referral system application 210 projected them as a match or not. Broadcasting provides a quick way to spread information about a job posting, which may be quickly shared by the employee's contacts with others in the social network once it has been posted. It is quite possible that a non-match contact may know the perfect person for a specific job posting. This also may be a good method to use when an employer is expanding, and has announced a number of similar positions simultaneously.

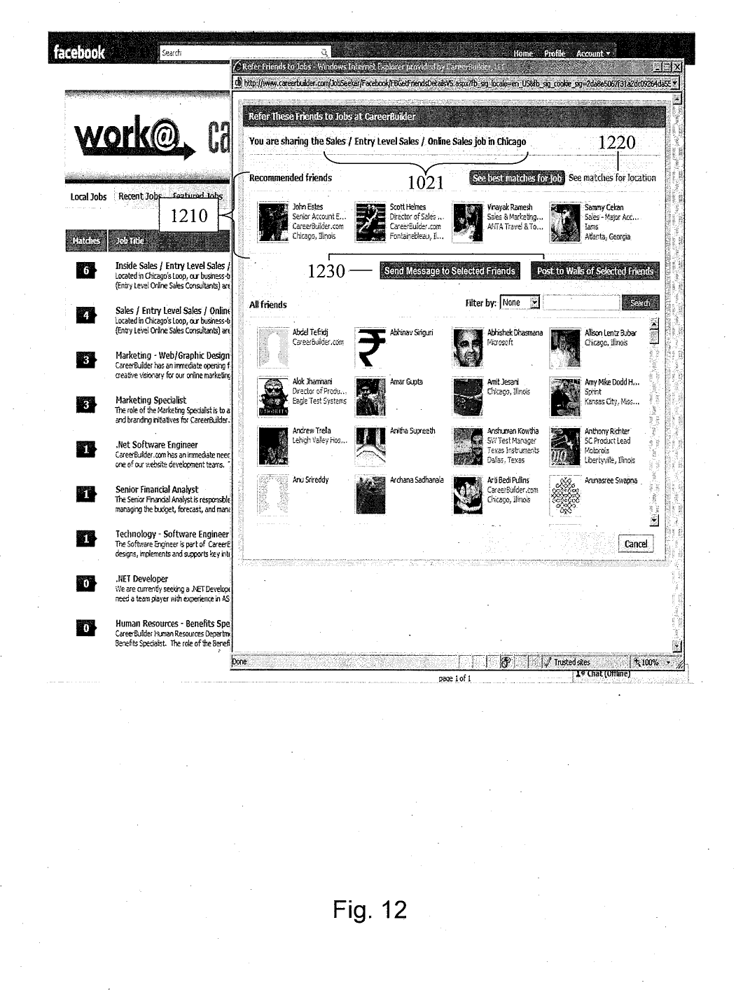

Returning to FIG. 10, by selecting the matches link 1026 corresponding to a particular job description 1022, the referrer application interface 240 will display a matched contacts screen similar to that of FIG. 12. As shown in FIG. 12, the employee has requested the matches link 1026 corresponding to the “Sales/Entry Level Sales/Online Sales job in Chicago” job title 1021. In response, contact referral system application 210 has generated a new window wherein it identifies the contacts it has matched with the selected job posting, such as through the recommended friends bar 1210 along the top of the display. From this point, the employer may elect to inform one or more of the matched contacts about the job posting, and that they were identified as potentially qualified. In some embodiments, such as that illustrated in FIG. 12, the employee's other contacts that were not matched are also listed and may be selected for receiving the job posting information. In a sense, this allows the employee to “override” the matching process in cases where, for instance, the employee feels a particular contact is especially suited for the position despite the fact that the contact's qualifications are not reflected in contact data available to the contact referral system 100.

As shown in FIG. 12, through the Facebook® application interface used, the employee is given an option to send the job posting information as a targeted message to the selected contact, or to post the job posting information on the selected contact's wall. The illustrated embodiment also provides an optional view to show contacts matching the location of the selected position using link 1220. While the default view shows only matched contacts in the recommended friends bar 1210, selecting link 1220 will separate out all contacts from the same location of the job availability. This feature provides a quick way for the employer to focus only on those contacts that would not have to move in order to fill the vacancy.

Ultimately, contact referral system 100 is designed with the understanding that the employee is in the best position to know whether any of the matched contacts would be interested in the job posting, and whether they would be a good fit for the position. The system also capitalizes on the fact that the matched contact is much more likely to read and consider information about a potential job opportunity when the information is received from someone they know personally. Furthermore, the matched contacts are likely to be encouraged about the position when they learn from the employee that they have already been pre-determined to be a potential fit. Thus, though in some embodiments the contact referral system application 210 may use the available contact data to send information to the matched contact after the completion of the matching process without intervention from the employee, it is preferred that the employee make the determination and send the job information to the matched contact.

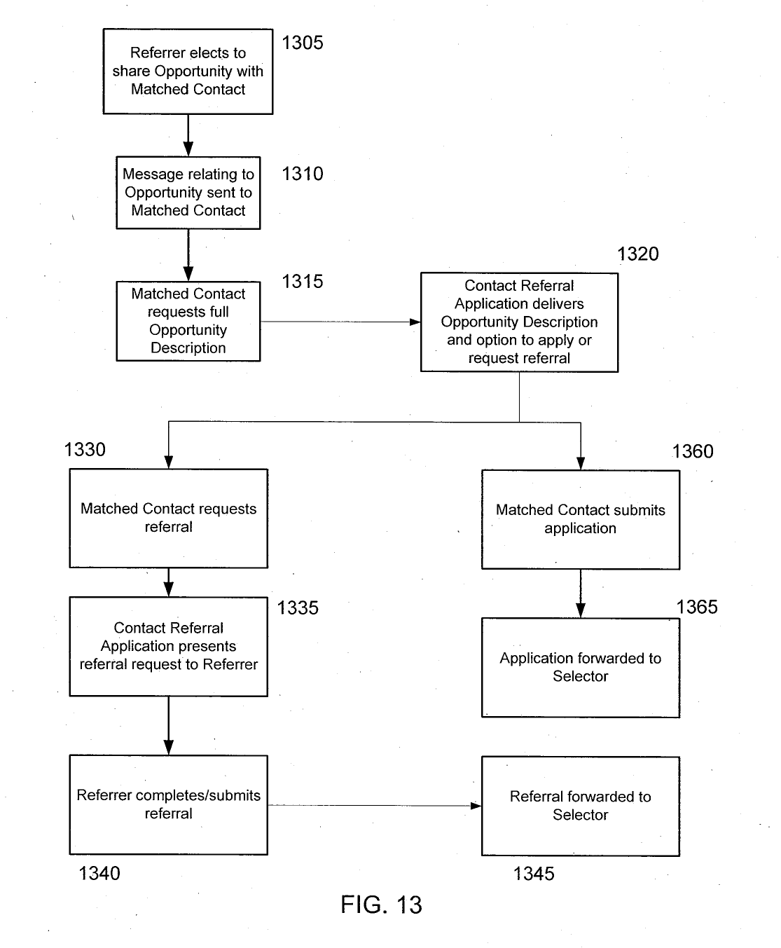

FIG. 13 is a flow chart that depicts typical steps taken once a referrer has executed contact referral system application 210, and has received matching results through referrer application interface 240 indicating that a contact has been matched with an opportunity. As discussed above, at step 1305, the referrer must first determine if they feel the matched contact is a good fit for the opportunity and would be interested in applying. Assuming this to be the case, the referrer elects to send the job posting, such as by selecting the “send” or “post” links 1230 in the display of FIG. 12, causing the opportunity description data to be sent to the matched contact (step 1310).

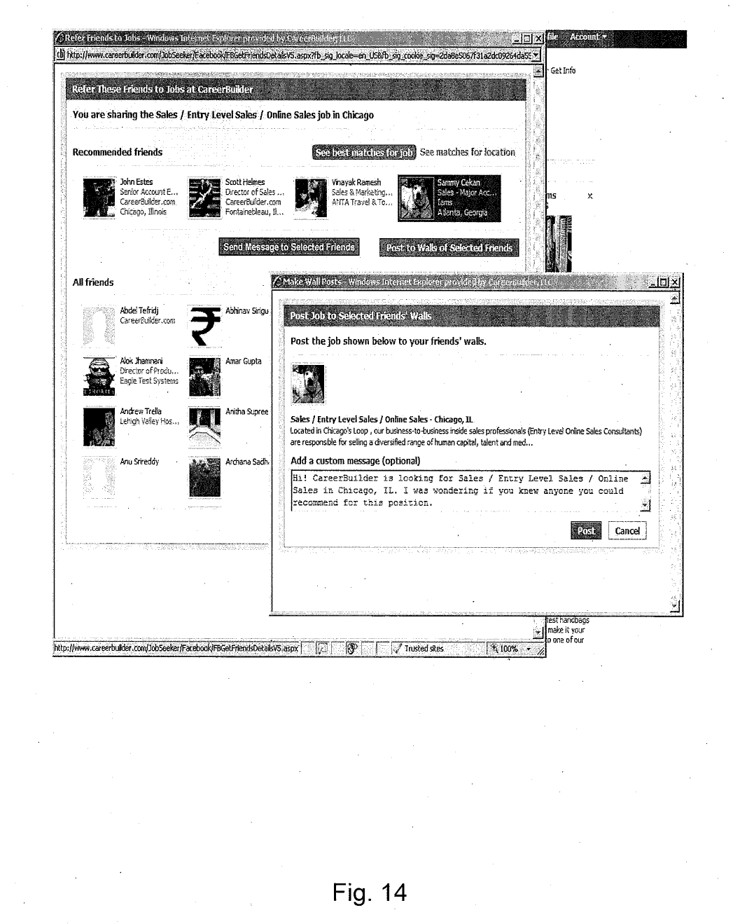

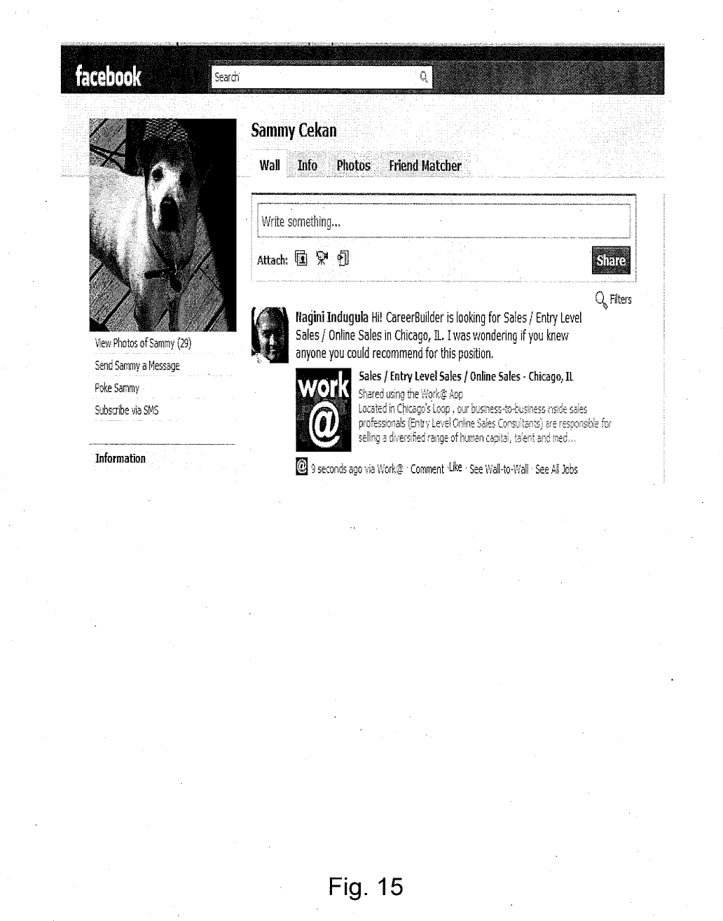

FIG. 14 shows a sample screen display where a matched contact has been selected by an employee to receive notice of the “Sales/Entry Level Sales/Online Sales job in Chicago” position by way of posting the information to the matched contact's FaceBook® wall. As indicated, contact referral system application 210 has produced a new window through referrer application interface 240 in response to this request. In the illustrated embodiment, this new window also provides the opportunity for the employee to provide a custom message to accompany the post. Finally, FIG. 15 shows the message as it might appear on the matched contact's “wall.”

Thus, in the illustrated embodiment, delivery of the job posting information is carried out inside of the social network by sending a message to the matched contact's social network “inbox,” or by posting the information directly on the matched contact's “wall.” However, in other embodiments, the message may be sent external to the social network, such as by sending the information to a traditional email account belonging to the matched contact. Such an email account would be available for use by contact referral system application 210 because the email address would be a component of the contact data. In any event, the matched contact need not download contact referral system application 210 in order to retrieve and respond to the message.

At step 1315, the matched contact receives the message from the referrer and requests the full opportunity description data. Then, at step. 1320, contact referral system application 210 presents the opportunity description data to the matched contact through contact application interface 250, which may be through a social network application interface 220. Alternatively, the opportunity description data could be presented by contact referral system application 210 directly in response to the referrer's authorization without request from the matched contact. Again, the display of FIG. 13 can be presented through the social network interface or through an external interface, such as an email application or a stand-alone website.

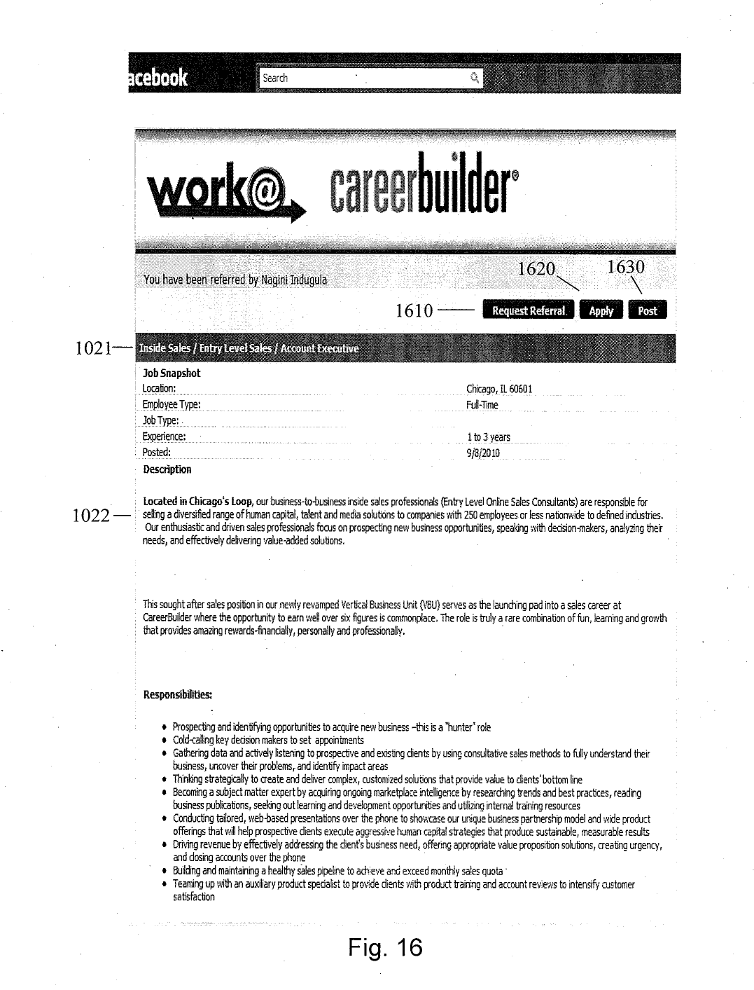

FIG. 16 provides an example screen display of the full job posting information as it might be presented to the matched contact. The display screen provides the job title 1021, job description 1022, and also links for the matched contact to either apply for the job or request a referral from the employee that caused the job posting to be forwarded to the matched contact. In the illustrated embodiment, which is again presented through the FaceBook® application interface, the display screen also provides the option for the matched contact to post the job description to one of his or her contacts. Depending on the employer's capabilities and preferences, selecting apply link 1620 may allow the matched contact to apply directly through the employer's website. Alternatively, contact referral system application 210 may continue to interact with the matched contact through contact application interface 250 to receive the application and forward it to the employer through other means. These steps are shown at 1360 and 1365 of FIG. 13.

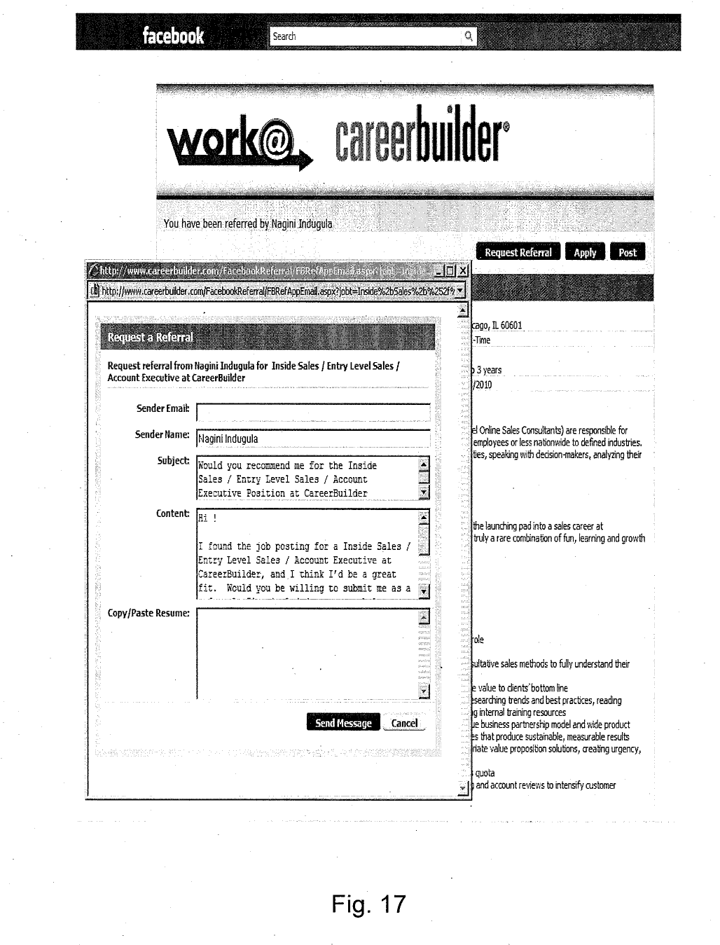

Finally, request referral link 1630 allows the matched contact to send a request for a referral back to the employee who initially executed the contact referral system application 210. In the illustrated embodiment, selection of link 1630 by the matched contact will cause application 210 to generate a referral request window, an example of which is shown in FIG. 17. This window can be designed to pre-populate with certain information like that shown. The request may be delivered through the social network, to an email address of the matched contact's choosing (as shown), or directly to the employee's work email account automatically by contact referral system application 210. A benefit of sending directly to the employee's work email is that it will be within a secure environment wherein a referral may be submitted to the employer using the employer's communication network.

If the employee took the time to execute the matching process and inform the matched contacts of the corresponding job postings, it is likely that the employee will also submit a referral if asked. This may be further encouraged by contact referral system application 210 providing a standardized referral template through referrer application interface 240 that asks specific questions to the employee about the contact so as to guide the referral creation process. Generating referrals in a standardized format may also assist the employer in culling through the information it receives about prospective candidates for job postings. The request for, creation of, and submittance of a referral are shown as steps 1330 through 1345 of FIG. 13. In alternative embodiments, contact referral system application 210 may automatically generate a request for a referral from the referrer upon submission of an application by the matched contact.

Though it may be desirable to receive referrals in a standardized format, it is understood that a referral from one referrer may not carry the weight that a referral from another referrer might carry. For example, in the employer/job posting scenario, the weight given a referral will typically depend on things such as the referring employee's time with the employer, their performance over that time period, the relation of the referring employee's job assignment to the job vacancy to be filled, and the value of the referrals they have provided in the past. Some of this information may not be available to contact referral system application 210. However, because the application 210 will have access to the information the referring employee has posted on the social network about his or her own work history, education, and background, contact referral system application 210 can consider this information and deliver the referral to the selector along with a projected weight. For instance, given two referrals for job posting 61 of FIG. 6, a referral from an employee identifying herself as a software engineer with ten years service to the employer would be weighted more heavily than a referral from a sales associate with two years of service.

Contact referral system application 210 records each step that is taken by referrer and their contacts on contact referral system 100. This information is used by a contact referral system administrator to generate reports for the selector. These reports indicate usage of contact referral system 100, such as the number of the selector's referrers that have downloaded the contact referral system application 210, the number of times system application 210 has been executed by those referrers, the number of contact data summary records that have been created as a result of those executions, the number of times a given opportunity has been reviewed by referrer contacts through application 210, and the number of applications that have been submitted from those contacts for that opportunity. With these reports, the selector can evaluate the effectiveness of the contact referral system 100 and can request adjustments where necessary, such as to the sensitivity of the matching process as discussed above.

Selectors may provide feedback on the contact referral system 100 to system administrators when a position is filled as a result of a contact referral. Where the selector is an employer, this information can also be linked to the employer's referral reward program, designed to further incentivize its employees to participate in the referral process. This incentive may be in the form of a monetary finder's fee or other valuable reward given to an employee who refers a contact that is ultimately placed in a vacant position. This award could be much less than a typical headhunter's finder fee, yet still provide adequate incentive for employee participation in the referral program.

Though the initial announcement of a referral incentive program, and the availability of the contact referral system application 210, is likely to create a buzz among referrers and result in a spike of contact referrals, this activity may fade over time without occasional reminders. The contact referral system 100 itself can also serve this purpose. For example, because the system records and tracks referrer usage of contact referral system application 210, and also performs step 516 periodically to pull in new opportunity descriptions from the selector, the system can provide useful, personalized reminders to referrers to execute the application 210. These reminders can be delivered to the user as messages through the social network on which the application 210 has been downloaded. Such a message might inform a referrer, for instance, that it has been three weeks since they have executed the contact referral system application 210, and that the selector has added twelve new opportunities since that time. Through such practices, referrers will continue to be reminded of the system's utility, and why it should be used. Accordingly, referrals and applications will continue to stream in as new opportunities are submitted to the system.

The embodiment of the contact referral system 100 that has been shown and described above works in cooperation with a social network application, such as FaceBook®. However, alternate embodiments provide that a component of contact referral system application 210 exists as a stand-alone, executable software program that can be downloaded directly to and executed from referrer communication device 140. In this case, there would be no need to use social network application interface 220. Rather, referrer application interface 240 would exist as a separate interface, or may be housed within an Internet browsing interface such as Internet Explorer®. In this configuration, the subsidiary component of contact referral system application 210 housed on referrer communication device 140 cooperates through the network with the main component of the application residing on contact referral system server 110 to execute the application and perform the matching.

The main component on the server is responsible for performing the vast majority of all of the functions described above in association with the social network embodiments. However, the subsidiary component gathers the referrer's contact data by pulling together contact information from files used by other applications on the referrer communication device 140. It may also download contact information stored on various social network servers when the referrer uses communication device 140 to connect with those servers. In this manner, the subsidiary component of contact referral system application 210 can combine contact data from the referrer's various social networks with the contact data in the referrer's email program such as Microsoft Outlook®, the referrer's address book files associated with other software programs, or other files of stored contact information on the device 140. This consolidated contact information may then be delivered to contact referral system server 110 for processing into contact data summary records by the main component of contact referral system application 210. As explained above, the corresponding contact data record summaries that will be created will only be as useful as the level of detail available in the contact data related to the associated contact.

In yet another embodiment, the contact referral system application 210 could remain entirely on contact referral system server 110, but execute through a stand-alone Internet website associated with the contact referral system 100. Once again, no social network application interface would be used, but instead of referrer application interface 240 being launched from an executable program stored on referrer communication device 140, it would be launched through an Internet browser window by the referrer upon visiting the stand-alone website, logging in, and launching the contact referral system application 210. In this case, the referrer would, at least initially, have to grant the application permission to access the referrer's contact data on referrer communication device 140 and/or on the various social network server's 120 on which the referrer has stored such data.

Accordingly, it should now be clear how contact referral system 100 can be used by employers or other selectors to encourage and induce quality referrals from its employees or other referrers. Any process descriptions or blocks in the figures, such as those of FIGS. 4, 5 and 13, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described exemplary embodiments of the present invention, and particularly any “preferred” embodiments, are possible examples of implementations, merely set forth for a clear understanding of the principles of the invention. Many other variations and modifications may be made to the above-described embodiments of the invention without substantially departing from the spirit and principles of the invention. All such modifications are intended to be included herein within the scope of this disclosure and the present invention and protected by the following claims.

What is claimed is:

1. A system for soliciting applications responsive to an opportunity from at least one referrer known to a selector comprising:
a server connected to a referrer communication device through a computer network for receiving instruction from the referrer communication device to evaluate contact data, wherein the contact data comprises information relating to the referrer's personal or business contacts;
a database associated with the server for storing opportunity description data corresponding to the opportunity; and
a processor associated with the server for comparing the contact data with the job opportunity description data to identify at least one matched contact.

2. The system of claim 1, wherein the processor generates a opportunity description summary record representative of the opportunity description data.

3. The system of claim 1, wherein at least a portion of the contact data is obtained from files stored on the referrer computing device, and wherein the referrer initially entered the portion of contact data in to the referrer computing device.

4. The system of claim 1, wherein at least a portion of the contact data is obtained from a social network server to which the referrer's contacts initially submitted the portion of contact data.

5. The system of claim 4, wherein the processor generates a contact data summary record representative of the contact data for each of the referrer's personal or business contacts for which information is available on the social network server.

6. The system of claim 1, wherein the server transmits match data to the referrer computing device, the match data indicative of which of the referrer's personal or business contacts were determined by the processor to be matched contacts.

7. The system of claim 6, wherein the match data comprises a ranking of the matched contacts for each opportunity such that the matched contacts are ranked by the likelihood that they are the most qualified for the opportunity.

8. The system of claim 6, wherein the server receives from the referrer communication device referral data corresponding to the opportunity and at least one matched contact.

9. The system of claim 6, wherein the server receives a request from the referrer communication device to share the opportunity description data with the at least one matched contact.

10. The system of claim 9, wherein the server transmits at least some of the opportunity description data to at least one matched contact communication device connected to the server through the network.

11. The system of claim 10, wherein the referrer communication device receives a request for referral data relating to the opportunity from the at least one matched contact communication device.

12. The system of claim 10, wherein the server receives application data relating to the opportunity from the at least one matched contact communication device.

13. A method for recruiting comprising the steps of:
receiving to a server opportunity description data from a selector defining qualifications relating to an opportunity offered by the selector;
receiving to the server a request transmitted from a referrer communication device to evaluate contact data relating to one or more of the referrer's personal or business contacts;
processing the contact data and the opportunity description data to match at least one of the referrer's personal or business contacts with the opportunity; and
transmitting match data to the referrer communication device, wherein the match data identifies the at least one matched contact.

14. The method of claim 13 further comprising the steps of:
transforming the opportunity description data into a standardized opportunity description summary record representative of the opportunity description data;
transforming the contact data into at least one standardized contact data summary record, such that there exists one contact data summary record representative of the contact data for each of the referrer's personal or business contacts identified by the contact data; and
comparing at least one standardized contact data summary record to the standardized opportunity description summary record to determine which of the referrer's personal or business contacts are matched contacts.

15. The method of claim 13, wherein at least a portion of the contact data is obtained from files stored on the referrer computing device, and wherein the referrer initially entered the portion of contact data into the referrer computer device.

16. The method of claim 13, wherein at least a portion of the contact data is obtained from a social network server to which the referrer's contacts initially submitted the portion of contact data.

17. The method of claim 13, wherein the at least one matched contact comprises a plurality of matched contacts, and wherein the match data comprises a ranking of the matched contacts according to the likelihood that those contacts are qualified to fulfill the opportunity.

18. The method of claim 13, wherein said processing step further comprises the steps of:
identifying opportunity description attributes from within the opportunity description data;
identifying and quantifying, for the contact data relating to each of the referrer's one or more personal or business contacts, contact attributes correlating to said opportunity description attributes; and
determining a referrer's personal or business contact to be a matched contact if a sufficient number of contact attributes of said personal or business contact correlate to the opportunity description attributes.

19. The method of claim 13, further comprising the step of receiving from the referrer communication device to the server a request to share the opportunity description data with at least one matched contact.

20. The method of claim 19, further comprising the step of transmitting at least some of the opportunity description data to at least one matched contact communication device connected to the server through the network.

21. The method of claim 20, further comprising the steps of receiving a request for referral data relating to the opportunity from the at least one matched contact communication device and transmitting the request to the referrer communication device.

22. The method of claim 20, further comprising the step of receiving application data relating to the opportunity from the at least one matched contact communication device.

23. The method of claim 13, further comprising the steps of receiving from the referrer communication device referral data corresponding to the opportunity and at least one matched contact, and transmitting the referral data to the selector.

24. A method for recruiting comprising the steps of:
making available to at least one referrer an application capable of interacting with a social network interface to identify and retrieve contact data corresponding to the referrer's personal or business contacts to which the at least one referrer is connected through the social network interface;
generating opportunity description data corresponding to the opportunity;
granting a server access to the opportunity description data for the purpose of that server retrieving the opportunity description data and comparing it to the contact data in order to identify matched contacts; and
receiving an application for the opportunity, wherein the application was completed by at least one of the matched contacts.

25. A method of referring personal or business contacts for an opportunity comprising:
connecting to a computerized social network through a social networking interface;
creating a profile on the computerized social network;
establishing connections to the profiles of personal or business contacts through the computerized social network;
downloading an application from a server onto the social network profile;
granting the application access to the profiles of personal or business contacts;
reviewing match data received from the server to determine which personal or business contacts are matched contacts;
submitting opportunity description data related to the opportunity to a matched contact; and
submitting a referral to a selector referring a matched contact for the opportunity.
